(19) United States
(12) Patent Application Publication
(10) Pub. No.: US 2012/0043449 A1
(43) Pub. Date: Feb. 23, 2012

(54) CLAMP ASSEMBLY

(76) Inventor: Sajan "Joseph" Jacob, Norcross, GA (US)

(21) Appl. No.: 12/859,682

(22) Filed: Aug. 19, 2010

(51) Int. Cl. F16B 2/02; F16M 13/00

(52) U.S. Cl. 248/534; 24/457

(57) ABSTRACT

A clamp assembly comprising two brackets. Each bracket may include an elongated end, a curved section adjacent the elongated end, a channel formed by the curved section, and a mating surface adjacent the channel. When the mating surfaces of each bracket are in mating contact with each other, the channels of each bracket are substantially aligned with each other to form a shaft aperture. The brackets may be fitted together via a tongue and groove configuration and are coupled by way of mechanical fasteners at connection points on each bracket. Each bracket may comprise a coupling area that is configured to engage a mechanical fastener. The clamp assembly mounts to a shaft comprising a plurality of notched segments, wherein each notched segment has a cross-sectional shape that is substantially similar to the shaft aperture cross-sectional shape. The shape of the shaft aperture and the cross-sectional shape of the shaft may be a rounded rectangle, so that the mounted clamp assembly will not rotate around the shaft when rotational force is applied thereto. The plurality of notched segments may be rotated angularly relative to each other.

### FIELD OF THE INVENTION

The field of the invention relates to clamps for mounting rods or other load-bearing structures substantially perpendicularly to a shaft.

### BACKGROUND

Wind is an increasing source of energy for driving wind turbines, windmills, and the like, for the production of electrical power. Traditionally, horizontal axis wind turbines were used to power electric generators. However, these horizontal axis wind turbines have several drawbacks. For example, the wind direction may impact the ability of a horizontal axis wind turbines to operate efficiently as the horizontal axis wind turbines must be rotated to face the wind, the large-scale arc of rotation poses a safety threat to aircraft and birds, large-scale horizontal axis wind turbines create a substantial amount of noise due to the speed of rotation at the tips of the blades, and the large-scale size is impractical for single home or other small-scale applications.

In recent years, there has been a transition toward vertical axis wind turbines. The design of the wind turbine blades for these vertical axis wind turbines allow the wind turbines to rotate regardless of the wind direction, thus addressing one of the more substantial drawbacks of horizontal axis wind turbines. The vertical axis wind turbine design has a quieter operation because the speed of rotation at the outermost diameter does not reach the speed experienced with the large-scale horizontal axis wind turbines.

In some cases, the vertical axis wind turbine employs two wind turbine blades that twist along the length of the vertical shaft of the wind turbine in a configuration that may be referred to as a “helical shape.” The helical shape results in maintaining some part of the wind turbine blade facing the wind regardless of the wind direction. This wind turbine blade configuration requires that the wind turbine blade be connected at various heights along the vertical shaft of the wind turbine and at various positions around the perimeter of the vertical shaft. To secure the wind turbine blade at the various positions and heights, a shaft design and clamp assembly design is needed that will prevent the wind turbine blade from rotating axially or translating vertically along the shaft. Moreover, the needed clamp designs must be inexpensive to manufacture, simple to mount at desired orientations along the length of the shaft, and strong enough to support the variable loads and forces of the wind turbine blades.

### SUMMARY

Embodiments of the invention provide a clamp assembly comprising two substantially identical mechanically coupled brackets. Each bracket may include an elongated end, a curved section adjacent the elongated end, a channel formed by the curved section, and a mating surface adjacent the channel. When the mating surfaces of each bracket are in mating contact with each other, the channels of each bracket are substantially aligned with each other to form a shaft aperture.

In some embodiments, the mating surface includes a tongue and a groove, wherein the tongue of the first bracket is coupled to the groove of the second bracket, and wherein the tongue of the second bracket is coupled to the groove of the first bracket. In other embodiments, each bracket comprises at least two connection points that are substantially aligned with each other when the two brackets are coupled. At least two fasteners may be coupled to the at least two aligned connection points.

In some embodiments, each bracket further comprises a coupling area, wherein the coupling area is configured to engage a mechanical fastener. Similarly, the elongated end of each bracket may be configured to engage a mechanical fastener. In these embodiments, the coupling area may be coupled to a wind turbine blade, and the elongated end may be coupled to a rod.

In some embodiments, the shaft aperture has a shape that is configured to couple the clamp assembly to a shaft having a cross-sectional shape that is substantially similar to the shaft aperture cross-sectional shape. The shape of the shaft aperture and the cross-sectional shape of the shaft may be a rounded rectangle, so that the mounted clamp assembly will not rotate around the shaft when rotational force is applied thereto. In some embodiments, the clamp assembly mounts to a shaft comprising a plurality of notched segments, wherein each notched segment has a cross-sectional shape that is substantially similar to the shaft aperture cross-sectional shape. The plurality of notched segments may be rotated angularly relative to each other.

### BRIEF DESCRIPTION OF THE DRAWINGS

FIG. 1A is a side view of a bracket according to certain exemplary embodiments of the present invention.

FIG. 1B is a side view of the bracket of FIG. 1A coupled to another bracket to form a clamp assembly.

FIG. 2A is a side view of the bracket of FIG. 1A showing the locations of exemplary connection points.

FIG. 2B is a side view of the clamp assembly of FIG. 1B showing the locations of exemplary connection points.

FIG. 3A is a side view of the bracket of FIG. 1A showing the locations of additional exemplary connection points.

FIG. 3B is a side view of the clamp assembly of FIG. 1B showing the locations of additional exemplary connection points.

FIG. 4 is a side view of the clamp assembly of FIG. 1B showing a plurality of rods coupled to several of the exemplary connection points.

FIG. 5 is an exploded perspective view of the clamp assembly of FIG. 1B.

FIG. 6 is a perspective view of the clamp assembly of FIG. 1B.

FIG. 7 is a perspective view of the clamp assembly of FIG. 1B mounted to a shaft.

FIG. 8 is a perspective view of a shaft according to one embodiment of the present invention.

FIG. 9 is a top view of the shaft of FIG. 8 coupled to a plurality of clamp assemblies of FIG. 1B.

### DETAILED DESCRIPTION

Embodiments of the invention provide a clamp assembly for mounting rods or other load-bearing structures substantially perpendicularly to a shaft, such as a rotor shaft or an axle. For example, a clamp assembly of the present invention may be used for mounting rods to the rotor shaft of a wind turbine, where the rods are substantially perpendicular to the rotor shaft and are used to support the blades of the wind turbine. However, the inventive clamp assemblies described herein are by no means limited for use in the construction of wind turbines. Other suitable applications will be apparent to those of skill in the art after reading the following description of the exemplary embodiments.

Exemplary embodiments of the present invention will hereinafter be described with reference to the drawings, in which like numerals are used to indicate like elements. For the sake of convenience, the drawings are not drawn to scale or with precise perspective and any reference herein to exemplary dimensions of the inventive clamp assembly or elements thereof are not intended to be reflected as such in the drawings. In addition, directional references used herein, such as front, back, top, bottom, etc. are intended to be relative to ordinary or normal usage of the described clamp assembly and are therefore not to be taken as limiting of the present invention in cases where clamp assembly is used in other manners.

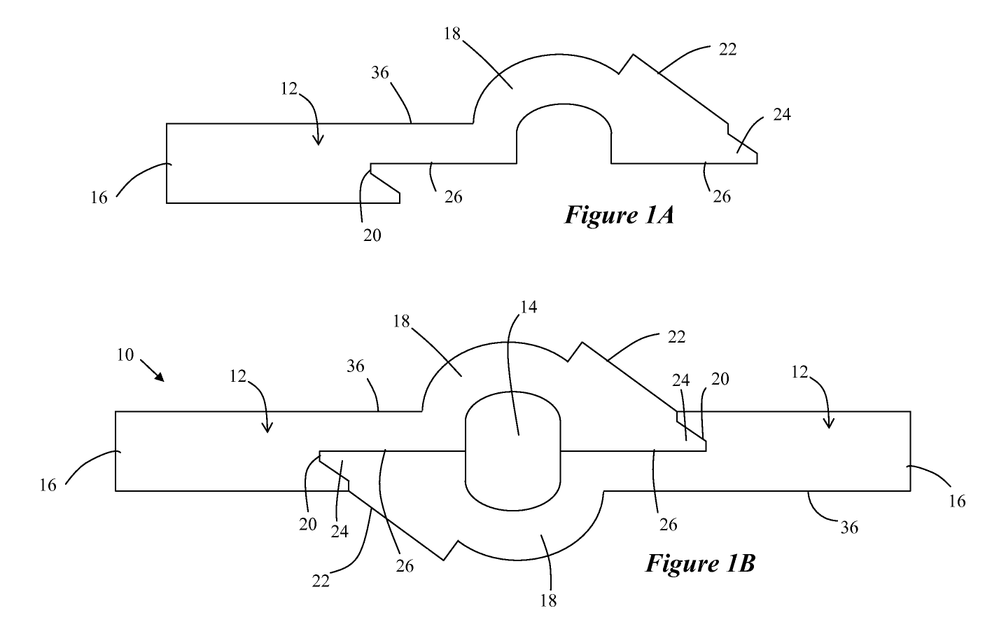

FIGS. 1A-7 illustrate certain exemplary embodiments of a clamp assembly 10 and its constituent brackets 12. As shown, the clamp assembly 10 comprises two brackets 12 coupled to one another. Each bracket 12 may be formed from a solid piece of iron, mild steel, aluminum, stainless steel, alloy steel, copper, brass, titanium, other metallic materials, composite materials, carbon fiber, plastics, fiberglass, or other similar materials. For example, the brackets 12 may be cut from a solid piece of material using techniques such as laser cutting, plasma cutting, waterjet cutting, milling, wire cutting, and other similar cutting processes. In some embodiments, the brackets 12 may be hardened and/or tensioned to provide additional strength. In other embodiments, for example where superior material strength is not a primary concern, the brackets 12 may be formed using die casting, molding or other suitable techniques.

As shown in FIG. 1A, an exemplary bracket 12 comprises an elongated end 16, a curved section 18, a groove 20, an angled coupling area 22, and a tongue 24. The shape of the bracket 12 is configured to couple with a second bracket 12 having a substantially identical or at least similar shape, thereby forming the clamp assembly 10 as shown in FIG. 1B. In the illustrated embodiments, each bracket 12 has a mating surface 26 that is configured to engage with a corresponding mating surface 26 of the second bracket 12. The mating surface 26 is defined as the portion of the surface of a bracket 12 that is placed in contact with an adjacent bracket 12 when the two brackets 12 are coupled to one another.

As also shown in FIG. 1B, the two brackets 12 can be engaged via a “tongue and groove” arrangement, where the tongue 24 of the first bracket 12 is inserted into the groove 20 of the second bracket 12, and the tongue 24 of the second bracket 12 is inserted into the groove 20 of the first bracket 12. One of skill in the relevant art will understand that the tongue and groove design may provide additional strength to the clamp assembly 10, which can be of particular importance in applications where the clamp assembly 10 will bear heavy loads and/or be subject to strong shears and other forces. However, the tongue and groove feature of the inventive clamp assembly 10 is considered to be an optional feature, which may not be required in all embodiments. In the illustrated embodiments, the tongue 24 of each bracket 12 is a wedge-shaped projection that corresponds to the wedge shape of the groove 20. However, one of skill in the relevant art will understand that many other suitable shapes and arrangement for achieving such a tongue and groove (or interlocking) effect between the brackets 12 are possible.

For purposes of symmetry and ease of manufacturing, the two brackets 12 of the clamp assembly 10 may have substantially identical or at least substantially similar overall shapes, as shown throughout the figures. In certain alternative embodiments, however, the two brackets 12 may have similarly-shaped mating surfaces 26, but differently-shaped non-mating surfaces 36, where the non-mating surface 36 is defined as the portion of the surface of the bracket 12 that is not placed in contact with the adjacent bracket 12 when the two brackets 12 are coupled to one another.

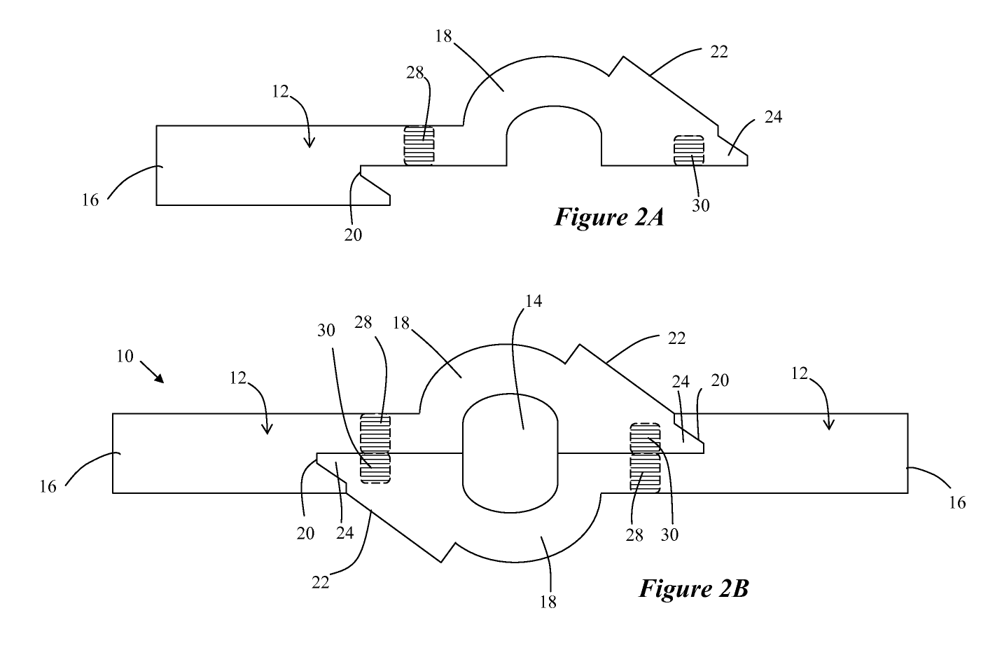

In certain exemplary embodiments, the two brackets 12 of the clamp assembly 10 may be secured to one another via mechanical fasteners, such as screws, bolts, pins, etc. For example, as shown in FIGS. 2A-2B, each bracket 12 may include connection points 28 and 30. These exemplary connection points 28 and 30 are positioned on each bracket 12 so as to achieve paired alignment when the two brackets 12 are coupled. In some embodiments, the connection points 28 and 30 are holes formed in the bracket 12. As shown, the hole of connection point 28 may extend completely through the bracket and the hole of connection point may 30 extends partially through the bracket 12. Both holes of connections points 28 and 30 may be tapped to form threads for accepting a screw or bolt. Alternatively, only the hole of connection point 30 may be tapped and the hole of connection point 28 may be shaped to receive the top of a bolt. In other embodiments, the connection points 28 and 30 may be bored holes that allow a bolt to pass through the coupled brackets 12, where the bolt is secured with a nut or a check-nut. Those skilled in the art will appreciate that other types of mechanical connection points 28 and 30 are also possible.

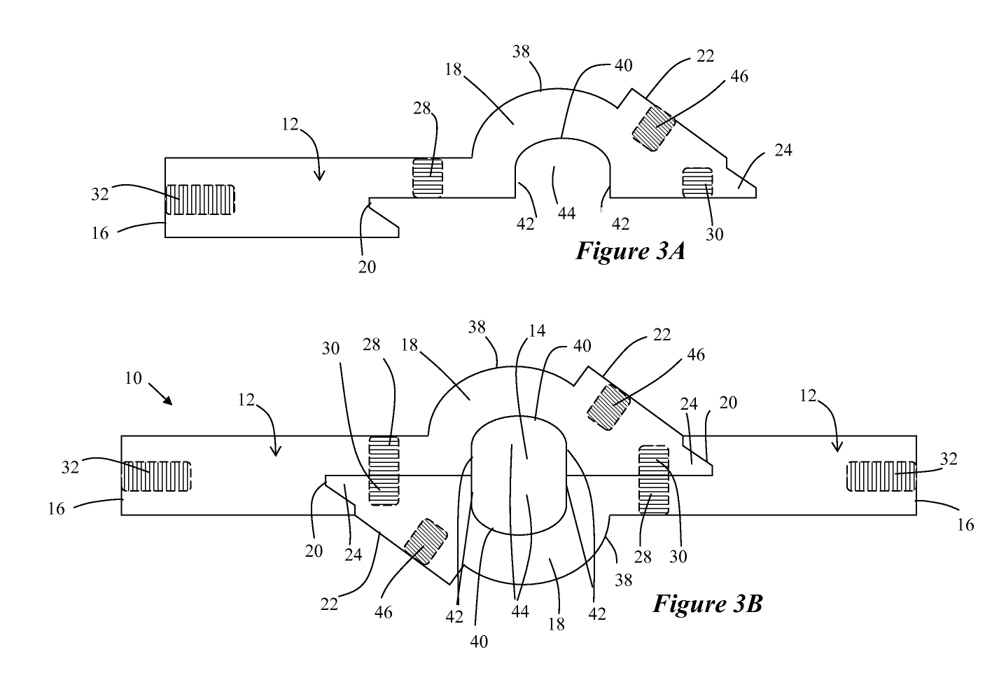

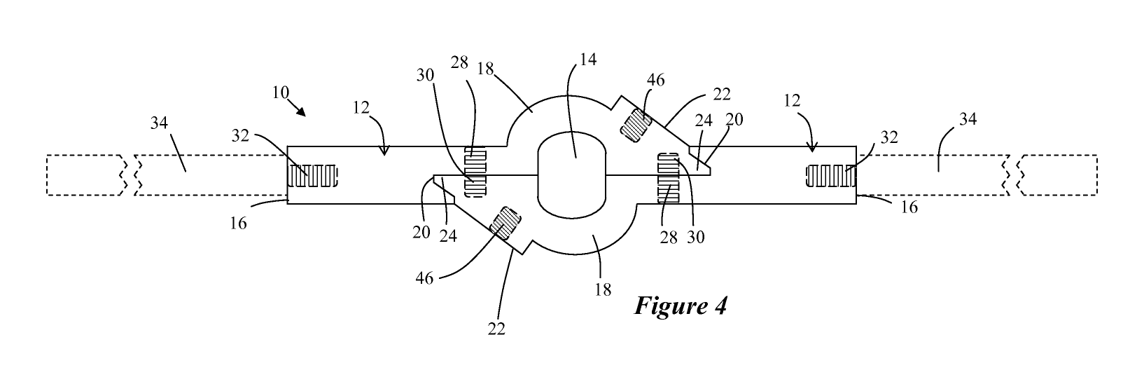

As shown in FIGS. 3A-3B, each bracket 12 may include one or more additional connection points 32 and 46. For example, connection point 32 may be a tapped hole formed in the elongated end 16 of the bracket and connection point 46 may be a tapped hole formed in the angled coupling area 22, each for accepting a screw, bolt, threaded projection, or other mechanical fastener. Connection points 32 may be used for coupling rods 34 or other load-bearing structures to the clamp assembly 10, as shown in FIG. 4. By way of example, the rods 34 may be used to support wind turbine blades (not shown). The rods 34 may be made from steel, aluminum, plastic, fiber glass, or any other material of suitable strength for the intended application. Each rod 34 may have a threaded end that screws into the tapped hole of the applicable connection point 32. Other mechanical connections between the rods 34 and the brackets 12 are possible. In certain embodiments, the strength of the clamp assembly 10 allows it to bear substantial load and shear or rotational forces. Thus, the clamp assembly 10 may be capable of supporting rods 34 having lengths up to 48 inches or longer, depending of course on the construction and material of the rods 34 and the application of the clamp assembly 10. In some embodiments, the rods 34 can be of variable length.

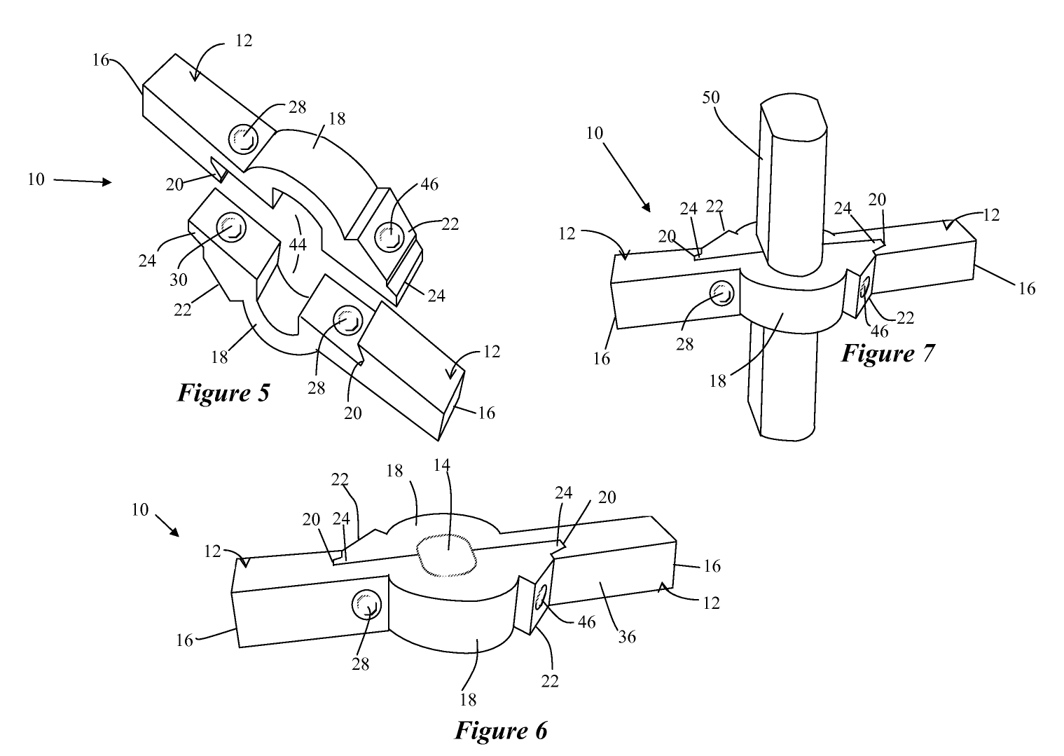

Optional connection points 46 may be included at the angled coupling area 22 positioned adjacent the tongue 24 and the curved section 18. These connection points 46 may be used for coupling objects or structures, such as portions of wind turbine blades or supports therefor (not shown) to the clamp assembly 10 at certain fixed angles, which angles are dictated by the configuration of the angled coupling area 22. One of skill in the relevant art will understand that the angled coupling area 22 may have configurations different from those shown in the figures. In some embodiments, as better illustrated in FIGS. 5-7, the elongated end 16 of each bracket 12 has a rectilinear cross-section. However, one of skill in the relevant art will understand that the elongated end 16 may have many other suitable cross-sectional shapes, including but not limited to circular, parabolic, I-shaped, T-shape, D-shape, U-shape, triangular, pentagonal, hexagonal, octagonal, or other similar shape.

In the embodiment illustrated in FIGS. 1-7, and as noted with reference numerals in FIGS. 3A-3B, the curved section 18 of each bracket 12 includes a curved exterior wall 38 and a curved interior wall 40. Each end of the curved interior wall 40 terminates with a substantially straight portion 42. As a result, the curved section 18 forms a substantially “U shaped” channel 44 surrounded by the mating surface 26 of the bracket 12. As shown, the curved section 18 of one bracket 12 may be substantially aligned with the curved section 18 of a second bracket 12, such that the respective channels 44 form an aperture 14 through the clamp assembly 10. In the illustrated embodiments, the aperture 14 has a rounded-rectangle shape where two sides are curved and two sides are straight. One of skill in the relevant art will understand that the aperture 14 may have many other suitable shapes, including but not limited to circular, parabolic, rectilinear, hexagonal, octagonal, or other similar shape.

As shown in FIG. 7, the clamp assembly 10 may be mounted to a shaft 50 that fits through the aperture 14. The shaft 50 preferably has a cross-sectional shape that is the same or substantially the same as that of the aperture 14. Thus, in embodiments where the aperture 14 of the clamp assembly 10 has a rounded-rectangle shape, the cross-sectional shape of the shaft 50 is also a rounded rectangle. In such embodiments, the rounded-rectangular shape of the aperture 14 and the shaft 50 prevents the clamp assembly 10 from spinning around the shaft 50 when a rotational force is applied to the clamp assembly 10. One of skill in the relevant art will understand that any appropriate cross-sectional shape that similarly couples the clamp assembly 10 to the shaft 50 while preventing the clamp assembly 10 from rotating around the shaft 50 may be used. In other embodiments, it may be desirable to have an aperture 14 with a cross-sectional shape that does allow the clamp assembly 10 to rotate around the shaft 50. As should be apparent, the curved section 18 of each bracket 12 may be sized and shaped so that the resulting aperture 14 fits tightly around the shaft 50. Accordingly, the two brackets 12 may be fitted around the shaft 50 and mechanically coupled together via connection points 28 and 30, and optionally engaged via the tongue and groove arrangement or other interlocking effect, thus mounting the clamp assembly 10 to the shaft 50

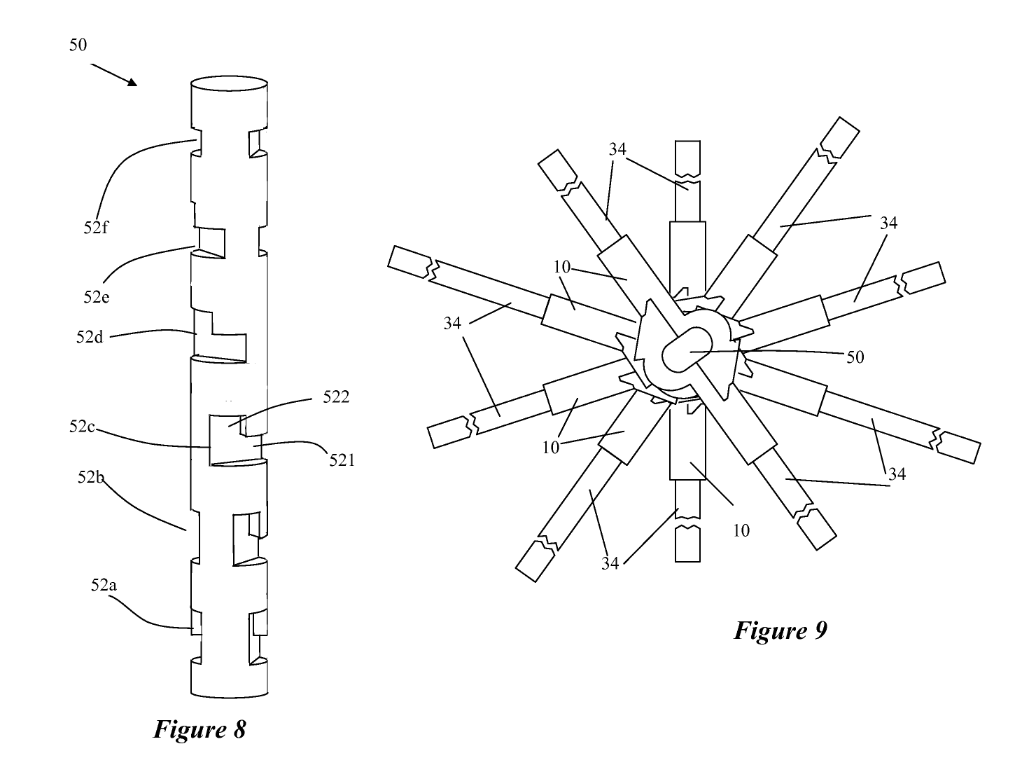

As shown in FIG. 8, the shaft 50 may have an overall circular cross-sectional shape. One of skill in the relevant art will understand that the shaft 50 may have many other suitable shapes, including but not limited to parabolic, rectilinear, hexagonal, octagonal, or other similar shape. In this embodiment, the shaft 50 may include at least one notched segment 52. As a result, the shaft 50, in the notched segment 52 location, has a cross-sectional shape that is the same or substantially the same as that of the aperture 14. In such embodiments, the rounded-rectangular shape of the aperture 14 and the similarly-shaped notched segment 52 of the shaft 50 prevents the clamp assembly 10 from spinning around the shaft 50 when a rotational force is applied to the clamp assembly 10.

As is shown in FIG. 8, the notched segment 52 may optionally include a half-segment 521 with a height that is the same or substantially the same as that of the thickness of the bracket 12. The opposing half-segment 522 that joins with the half-segment 521 has a height that is approximately twice that of the thickness of the bracket 12. This configuration allows an untrained installer to couple the clamp assembly 10 to the shaft 50 in a precise location and orientation without the need for technical expertise. Specifically, the first bracket 12 is coupled to the half-segment 521. The overall shape of the half-segment 521 is the same or substantially the same shape as the channel 44 and the thickness of the bracket 12 so that the first bracket 12 cannot move up/down or side-to-side when coupled to the half-segment 521. The double-sized height of the half-segment 522 allows the second bracket 12 to couple to the half-segment 522 above the location of the first bracket 12. Likewise, the overall shape of the half-segment 522 is the same or substantially the same shape as the channel 44 so that the second bracket 12 cannot move side-to-side when coupled to the half-segment 522, but can slide down the half-segment 522 to couple to the first bracket 12 in a tongue and groove arrangement.

In the embodiment shown in FIG. 8, the shaft 50 may include a plurality of notched segments 52a-f, each of which has a substantially identical cross-sectional shape. The segments 52a-f are positioned along the shaft 50, but each notched segment 52a-f is rotated a fixed amount relative to the adjacent notched segments. For example, in the illustrated embodiment, a second notched segment 52b is rotated approximately 36 degrees relative to a first notched segment 52a. Likewise, a third notched segment 52c is rotated approximately 36 degrees relative to the second notched segment 52b, so that the third notched segment 52c is rotated a total of 72 degrees from the first notched segment 52a. The fourth notched segment 52d is rotated approximately 36 degrees relative to the third notched segment 52c, so that the fourth notched segment 52d is rotated approximately 108 degrees relative to the first notched segment 52a. The fifth notched segment 52e is rotated approximately 36 degrees relative to the fourth notched segment 52d, so that the fifth notched segment 52 is rotated approximately 144 degrees relative to the first notched segment 52a. Finally, the sixth notched segment 52f is rotated approximately 36 degrees relative to the fifth notched segment 52e, so that the sixth notched segment 52f is rotated approximately 180 degrees relative to the first notched segment 52a. Thus, the sixth notched segment 52f and the first notched segment 52a are in alignment, but 180 degrees out of phase, relative to each other.

In this embodiment, the shaft 50 comprises a plurality of notched segments 52a-f in a rotating pattern so that a plurality of clamp assemblies 10 may be readily affixed to the shaft 50 in predetermined angles and positions along the length of the shaft 50. When a clamp assembly 10 has been mounted to each notched segment 52a-f, rods 34 may be coupled to each elongated end 16 thereof, as shown in FIG. 9. In this configuration, a pair of helical-shaped wind turbine blades (not shown) may be supported by the rods 34 (and, optionally, the angled coupling areas 22 of the clamp assembly 10). The heights and angular configurations of the rods 34, relative to one another, may be spaced to conform to the twisting shape of the helical wind turbine blades. In some embodiments, rods 34 can be of different lengths, which will change the shape and profile of the helical wind turbine blades. The shape of the wind turbine blades may be adjusted by, for example, changing the length of the rods 34 and/or by changing the shaft 50 to include a different rotation pattern of the notched segments 52a-f or different spacing of the notched segments 52a-f along the length of the shaft 50.

The foregoing is provided for purposes of illustrating, explaining, and describing embodiments of the present invention. Further modifications and adaptations to these embodiments will be apparent to those skilled in the art. The features and aspects of the present invention have been described or depicted by way of example only and are therefore not intended to be interpreted as required or essential elements of the invention unless otherwise so stated. It should be understood, therefore, that the foregoing relates only to certain exemplary embodiments of the invention, and that numerous changes and additions may be made thereto without departing from the spirit and scope of the invention as defined by any appended claims.

That which is claimed is:

1. A clamp assembly comprising two substantially identical mechanically coupled brackets, each bracket comprising:
an elongated end;
a curved section adjacent the elongated end, wherein the curved section forms a channel; and
a mating surface adjacent the channel;
wherein the mating surfaces of each bracket are in mating contact with each other so that the channels of each bracket are substantially aligned with each other to form a shaft aperture.

2. The clamp assembly of claim 1, wherein the mating surface of each bracket further comprises:
a tongue; and
a groove;
wherein the tongue of the first bracket is coupled to the groove of the second bracket; and
wherein the tongue of the second bracket is coupled to the groove of the first bracket.

3. The clamp assembly of claim 2, wherein each bracket further comprises at least two connection points, wherein the at least two connection points of each bracket are substantially aligned with each other when the two brackets are coupled.

4. The clamp assembly of claim 3, further comprising at least two fasteners coupled to the at least two aligned connection points when the two brackets are coupled.

5. The clamp assembly of claim 1, wherein each bracket further comprises a coupling area configured to engage a mechanical fastener.

6. The clamp assembly of claim 5, wherein the coupling area of each bracket is coupled to a wind turbine blade.

7. The clamp assembly of claim 1, wherein the elongated end of each bracket is configured to engage a mechanical fastener.

8. The clamp assembly of claim 1, wherein the elongated end of each bracket is coupled to a rod.

9. The clamp assembly of claim 1, wherein the clamp assembly is mounted to a shaft and wherein the shaft comprises at least one notched segment having a cross-sectional shape that is substantially similar to a shape of the shaft aperture.

10. A shaft and clamp assembly combination comprising:
a clamp assembly comprising two substantially identical mechanically coupled brackets, each bracket comprising:
a curved section, wherein the curved section forms a channel; and
a mating surface adjacent the channel;
wherein mating surfaces of each bracket are in mating contact with each other so that the channels of each bracket are substantially aligned with each other to form a shaft aperture having a cross-sectional shape; and
a shaft comprising a plurality of notched segments, wherein each notched segment has a cross-sectional shape that is substantially similar to the shaft aperture cross-sectional shape.

11. The shaft and clamp assembly combination of claim 10, wherein each notched segment is formed from a first half-segment and a second half-segment, wherein the second half-segment has a height that is twice the height of the first half-segment.

12. The shaft and clamp assembly combination of claim 10, wherein each notched segment is rotated approximately 36 degrees relative to the adjacent notched segments.

13. The shaft and clamp assembly combination of claim 10, wherein the mating surface of each bracket further comprises:
a tongue; and
a groove;
wherein the tongue of the first bracket is coupled to the groove of the second bracket; and
wherein the tongue of the second bracket is coupled to the groove of the first bracket.

14. The shaft and clamp assembly combination of claim 10, wherein each bracket further comprises at least two connection points, wherein the at least two connection points of each bracket are substantially aligned with each other when the two brackets are coupled.

15. The shaft and clamp assembly combination of claim 14, further comprising at least two fasteners coupled to the at least two aligned connection points when the two brackets are coupled.

16. The shaft and clamp assembly combination of claim 10, wherein each bracket further comprises a coupling area, wherein the coupling area of each bracket is configured to engage a mechanical fastener.

18. The shaft and clamp assembly combination of claim 10, wherein each bracket further comprises an elongated end configured to engage a mechanical fastener.

19. The shaft and clamp assembly combination of claim 18, wherein the elongated end of each bracket is coupled to a rod.

20. A clamp assembly comprising:
a first bracket and a second bracket;
wherein the first bracket comprises a first elongated end, a first curved section adjacent the first elongated end, a first tongue and a first groove, and wherein the first curved section forms a first channel;
wherein the second bracket comprises a second elongated end, a second curved section adjacent the second elongated end, a second tongue and a second groove, and wherein the second curved section forms a second channel;
wherein the first bracket is coupled to the second bracket such that the first tongue is coupled to the second groove, the second tongue is coupled to the first groove, and the first channel is substantially aligned with the second channel to form a shaft aperture.
